(19) United States
(12) Patent Application Publication
(10) Pub. No.: US 2016/0350800 A1
(43) Pub. Date: Dec. 1, 2016

(54) DETECTING COALITION FRAUD IN ONLINE ADVERTISING

(71) Applicant: Yahoo! Inc., Sunnyvale, CA (US)

(72) Inventors: Angus Xianen Qiu, Beijing (CN); Haiyang Xu, Beijing (CN); Zhangang Lin, Beijing (CN)

(21) Appl. No.: 14/761,043

(22) PCT Filed: May 29, 2015
(86) PCT No.: PCT/CN2015/080220

§ 371 Date: Jul. 15, 2015

(51) Int. Cl. G06Q 30/02

(52) U.S. Cl. CPC G06Q 30/0248; G06Q 30/0277

(57) ABSTRACT

The present teaching, which includes methods, systems and computer-readable media, relates to detecting online coalition fraud. The disclosed techniques may include grouping visitors that interact with online content into clusters, obtaining traffic features for each visitor, wherein the traffic features are based at least on data representing the corresponding visitor's interaction with the online content; determining, for each cluster, cluster metrics based on (one or more statistical values of) the traffic features of the visitors in that cluster; and determining whether a cluster is fraudulent based on the cluster metrics of the first cluster. For example, determining whether a cluster is fraudulent may include determining whether a first statistical value of the traffic features related to the first cluster is greater than a first threshold value, and/or determining whether a second statistical value of the traffic features related to the first cluster is lower than a second threshold value.

### BACKGROUND

1. Technical Field

The present teaching relates to detecting fraud in online or internet-based activities and transactions, and more specifically, to providing a representation of a relationship between entities involved in online content interaction and detecting coalition fraud when online content publishers or providers collaborate to fraudulently inflate web traffic to their websites or web portals.

2. Technical Background

Online advertising plays an important role in the Internet. Generally there are three players in the marketplace: publishers, advertisers, and commissioners. Commissioners such as Google, Microsoft and Yahoo!, provide a platform or exchange for publishers and advertisers. However, there are fraudulent players in the ecosystem. Publishers have strong incentives to inflate traffic to charge more from advertisers. Some advertisers may also commit fraud to exhaust competitors' budgets. To protect legitimate publishers and advertisers, commissioners have to take responsibility to fight against fraudulent traffic, otherwise the ecosystem will be damaged and legitimate players would leave. Many current major commissioners have antifraud system, which use rule-based or machine learning filters.

To avoid being detected, fraudsters may dilute their traffic or even unite together to form a coalition. In coalition fraud, fraudsters share their resources such as IP addresses and collaborate to inflate traffic from each IP address (considered as a unique user or visitor) to each other's online content (e.g., webpage, mobile application, etc.). It is hard to detect such kind of fraud by looking into a single visitor or publisher, since traffic is dispersed. For example, each publisher of online content owns distinct IP addresses, and as such, it may be easy to detect fraudulent user or visitor traffic if the traffic originates from only their own IP addresses. However, when publishers (or advertisers or other similar entities providing online content) share their IP addresses, they can collaborate to use such common pool to IP addresses to fraudulently inflate each other's traffic. In that, the traffic to each publisher's online portal or application is diluted and behavior of any one IP address or visitor looks normal, making detection of such frauds more difficult.

### SUMMARY

The teachings disclosed herein relate to methods, systems, and programming for providing a representation of relationships between entities involved in online content interaction and, detecting coalition fraud in online or internet-based activities and transactions where certain entities (e.g., online content publishers, providers, or advertisers) collaborate to fraudulently inflate web traffic toward each other's content portal or application.

In one example, a method, implemented on a machine having at least one processor, storage, and a communication platform capable of connecting to a network to detect online coalition fraud is disclosed. The method may include grouping visitors (or users) that interact with (e.g., click on, view, or otherwise consume) online content into clusters. The online content may be provided by or otherwise associated with one or more entities, e.g., publishers, advertisers, content providers, etc. Traffic features, which are based at least on data representing the corresponding visitor's interaction with the online content, may be obtained (e.g., generated, received, or determined) for each visitor. Further, cluster metrics may be determined for each cluster, e.g., based on the traffic features of the visitors in that cluster, and based on the cluster metrics of a cluster, it may be determined whether that cluster is fraudulent.

In another example, a system to detect online coalition fraud is disclosed is disclosed. The system may include a cluster generation unit, a cluster metric determination unit, and a fraudulent cluster detection unit. The cluster generation unit may be configured to group visitors or users that interact with online content into clusters. The cluster metric determination unit may be configured to determine, for each cluster, cluster metrics based on traffic features of each corresponding one of the visitors in that cluster, wherein the traffic features are based at least on data representing the corresponding visitor's interaction with the online content. And, the fraudulent cluster detection unit may be configured to determine whether a first of the clusters is fraudulent based on the cluster metrics of the first cluster.

Other concepts relate to software to implement the present teachings on detecting online coalition fraud. A software product, in accord with this concept, includes at least one machine-readable non-transitory medium and information carried by the medium. The information carried by the medium may be executable program code data, parameters in association with the executable program code, and/or information related to a user, a request, content, or information related to a social group, etc.

In one example, a machine-readable, non-transitory and tangible medium having data recorded thereon to detect online coalition fraud, where the information, when read by the machine, causes the machine to perform a plurality of operations. Such operations may include grouping visitors (or users) that interact with (e.g., click on, view, or otherwise consume) online content into clusters. The online content may be provided by or otherwise associated with one or more entities, e.g., publishers, advertisers, content providers, etc. Operations may further include obtaining traffic features, which are based at least on data representing the corresponding visitor's interaction with the online content, for each visitor. Further, cluster metrics may be determined for each cluster, e.g., based on the traffic features of the visitors in that cluster, and based on the cluster metrics of a cluster, it may be determined whether that cluster is fraudulent.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of various aspects of the methodologies, instrumentalities and combinations set forth in the detailed examples discussed below.

### BRIEF DESCRIPTION OF THE DRAWINGS

The methods, systems and/or programming described herein are further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 illustrates an example of a typical online interaction between entities that provide online content, and entities that interact with the online content, in accordance with various embodiments of the present disclosure;

FIGS. 2(a), 2(b) illustrate examples of systems in which representations of relationships between entities involved in online content interaction are generated and coalition fraud in online or internet-based activities and transactions is detected, in accordance with various embodiments of the present disclosure;

FIG. 3 illustrates an example of an activity and behavior processing engine, in accordance with various embodiments of the present disclosure;

FIG. 4 is a flowchart of an exemplary process operated at an activity and behavior processing engine, in accordance with various embodiments of the present disclosure;

FIG. 5 illustrates an example of a traffic-fraud detection engine, in accordance with various embodiments of the present disclosure;

FIG. 6 is a flowchart of an exemplary process for traffic fraud detection, in accordance with various embodiments of the present disclosure;

FIG. 7 illustrates an example of a vector representation generation unit, in accordance with various embodiments of the present disclosure;

FIG. 8 is a flowchart of an exemplary process for generation of vector representations of relationships between different entities, in accordance with various embodiments of the present disclosure;

FIG. 9 illustrates an example of a cluster metric determination unit, in accordance with various embodiments of the present disclosure;

FIG. 10 is a flowchart of an exemplary process for determining cluster metrics, in accordance with various embodiments of the present disclosure;

FIG. 11 illustrates an example of a fraudulent cluster detection unit, in accordance with various embodiments of the present disclosure;

FIG. 12 is a flowchart of an exemplary process for detecting fraudulent clusters, in accordance with various embodiments of the present disclosure;

FIG. 13 depicts the architecture of a mobile device which can be used to implement a specialized system incorporating teachings of the present disclosure; and

FIG. 14 depicts the architecture of a computer which can be used to implement a specialized system incorporating teachings of the present disclosure.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The present disclosure generally relates to systems, methods, and other implementations directed to providing a representation of relationships between entities involved in online content interaction and detecting coalition fraud in online or internet-based activities and transactions where certain entities (e.g., online content publishers, providers, advertisers, creative, etc.) collaborate to fraudulently inflate web traffic toward each other's content portal or application. In some cases, it may be hard to detect such kind of fraud by analyzing activities of a single entity (e.g., a visitor or a publisher) involved in online interaction, since online traffic is dispersed.

In accordance with the various embodiments described herein, to tackle the problem of online coalition fraud, both the relationship between entities (e.g., visitors and publishers) involved in interaction with online content (e.g., webpage view or click, ad click, ad impression, and/or ad conversion, on a webpage, in a mobile application, etc.), and traffic quality of such entities may be considered simultaneously. Accordingly, various embodiments of this disclosure relate to techniques and systems to generate or provide a representation of relationships between entities (e.g., visitors and publishers) involved in online content interaction (where the relationship representations may not be dominated by certain one or more entities). Further, various embodiments of this disclosure relate to grouping visitors into clusters based on their relationship representations, and analyze the visitors on a cluster level rather than individually, so as to determine whether the visitors or their clusters are fraudulent. Such analysis of visitor clusters may be performed based on cluster-level metrics, which, e.g., leverage statistics of traffic behavior features of visitors.

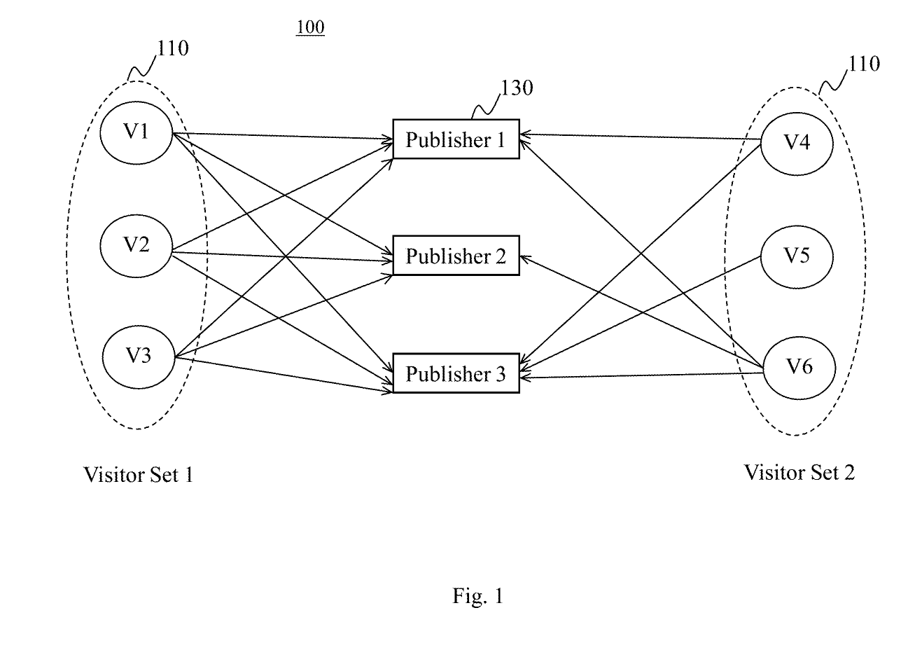

FIG. 1 illustrates a broad schematic 100 illustrating a typical online interaction between entities that provide or present online content (e.g., publishers 130), and entities that interact with or otherwise consume the online content (e.g., visitors 110). As illustrated, there may be different sets of visitors 110 (e.g., visitor set 1, visitor set 2) that may interact, via their respective electronic network-enabled devices, with the online content provided by one or more publishers 130 (e.g., at a website, webpage, mobile application, etc.). For the sake of explanation, visitor set 1 may represent visitors that collaborate with publishers 130 that intend of fraudulently inflate visitor traffic to each other's online content, and visitor set 2 may represent typical genuine users or visitors that interact with the online content provided by publishers 130. In some embodiments, each of publishers 130 may be provided or allocated certain distinct IP addresses, and the publishers 130 may pool or share their Internet Protocol (IP) addresses, where, e.g., visitors in visitor set 1 may be assigned those shared IP addresses, which they use to access the online content provided by publishers 130. Accordingly, when publishers 130 collaborate and share their IP address, they are able to dilute or disperse the sources and behavior of the traffic to their content, instead of getting the traffic from only a known set of IP addresses or visitors (which may be easier to detect).

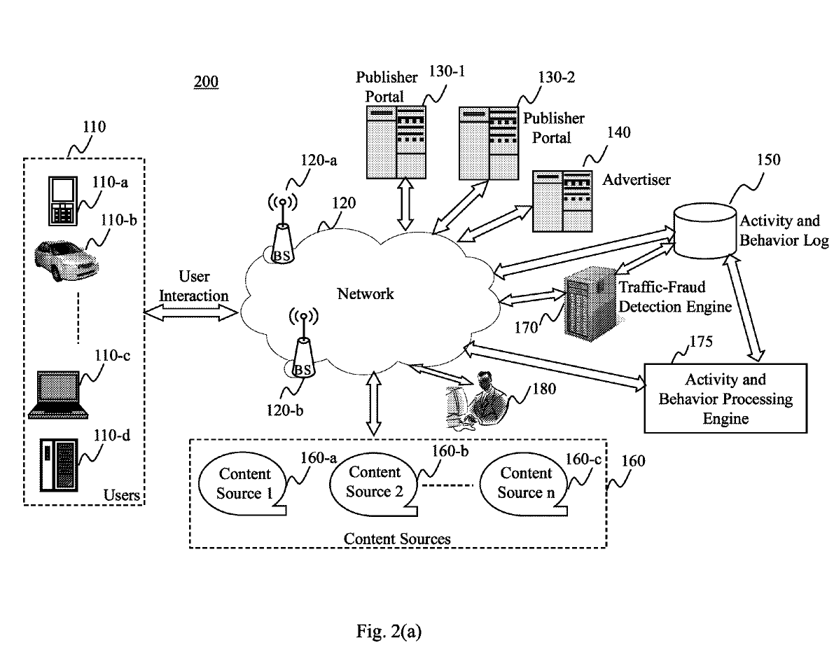

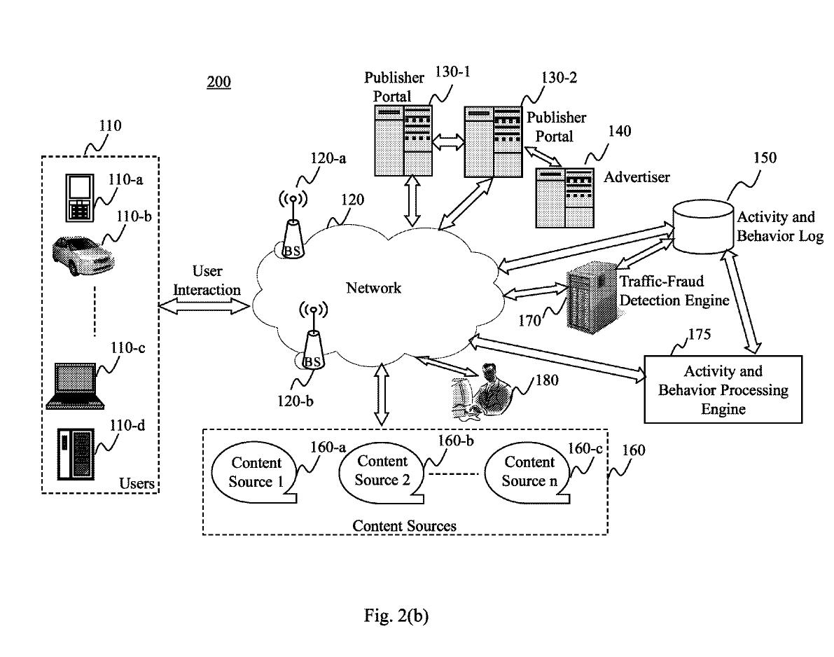

FIGS. 2a, 2b are high level depiction of different system configurations in which representations of relationships between entities involved in online content interaction may be generated and coalition fraud in online or internet-based activities and transactions may be detected, according to one or more embodiments of the present disclosure. As shown in FIG. 2(a), the exemplary system 200 may include users or visitors 110, a network 120, one or more publisher portals or publishers 130, one or more advertisers 140, an activity and behavior log/database 150, data sources 160 including data source 1 160-a, data source 2 160-b, . . . , data source n 160-c, a traffic-fraud detection engine 170, an activity and behavior processing engine 175 and a system operator/administrator 180.

The network 120 may be a single network or a combination of different networks. For example, a network may be a local area network (LAN), a wide area network (WAN), a public network, a private network, a proprietary network, a Public Telephone Switched Network (PSTN), the Internet, a wireless network (e.g., a personal area network, a Bluetooth network, a near-field communication network, etc.), a cellular network (e.g., a CDMA network, an LTE network, a GSM/GPRS network, etc.), a virtual network, or any combination thereof. A network may also include various network access points, e.g., wired or wireless access points such as base stations or Internet exchange points 120-a, . . . , 120-b, through which a data source may connect to the network in order to transmit information via the network. In one embodiment, the network 120 may be an online advertising network or an ad network, which connects advertisers 140 to publishers 130 or websites/mobile applications that want to host advertisements. A function of an ad network is aggregation of ad-space supply from publishers and matching it with advertiser demand. An ad network may be a television ad network, a print ad network, an online (Internet) ad network, or a mobile ad network.

Users 110 (interchangeably referred to herein as visitors 110) may be entities (e.g., humans) that intend to access and interact with content, via network 120, provided by publishers 130 at their website(s) or mobile application(s). Users 110 may utilize devices of different types that are capable of connecting to the network 120 and communicating with other components of the system 200, such as a handheld device (110-a), a built-in device in a motor vehicle (110-b), a laptop (110-c), or desktop connections (110-d). In one embodiment, user(s) 110 may be connected to the network and able to access and interact with online content (provided by the publishers 130) through wireless technologies and related operating systems and interfaces implemented within user-wearable devices (e.g., glasses, wrist watch, etc.). A user, e.g., 110-1, may send a request for online content to the publisher 130, via the network 120 and receive content as well as one or more advertisements (provided by the advertiser 140) through the network 120. When provided at a user interface (e.g., display) of the user device, the user 110-1 may click on or otherwise select the advertisement(s) to review and/or purchase the advertised product(s) or service(s). In the context of the present disclosure, such ad presentation/impression, ad clicking, ad conversion, and other user interactions with the online content may be considered as an “online event” or “online activity.”

Publishers 130 may correspond to an entity, whether an individual, a firm, or an organization, having publishing business, such as a television station, a newspaper issuer, a web page host, an online service provider, or a game server. For example, in connection to an online or mobile ad network, publishers 130 may be an organization such as USPTO.gov, a content provider such as CNN.com and Yahoo.com, or a content-feed source such as Twitter or blogs. In one embodiment, publishers 130 include entities that develop, support and/or provide online content via mobile applications (e.g., installed on smartphones, tablet devices, etc.). In one example, the content sent to users 110 may be generated or formatted by the publisher 130 based on data provided by or retrieved from the content sources 160. A content source may correspond to an entity where the content was originally generated and/or stored. For example, a novel may be originally printed in a magazine, but then posted online at a web site or portal controlled by a publisher 130 (e.g., publisher portals 130-1, 130-2). The content sources 160 in the exemplary networked environment 100 include multiple content sources 160-1, 160-2 . . . 160-3.

Advertisers 140, generally, may correspond to an entity, whether an individual, a firm, or an organization, doing or planning to do (or otherwise involved in) advertising business. As such, an advertiser 140 may be an entity that provides product(s) and/or service(s), and itself handles the advertising process for its own product(s) and/or service(s) at a platform (e.g., websites, mobile applications, etc.) provided by a publisher 130. For example, advertisers 14 may include companies like General Motors, Best Buy, or Disney. In some other cases, however, an advertiser 140 may be an entity that only handles the advertising process for product(s) and/or service(s) provided by another entity.

Advertisers 140 may be entities that are arranged to provide online advertisements to publisher(s) 130, such that those advertisements are presented to the user 110 with other online content at the user device. Advertisers 140 may provide streaming content, static content, and sponsored content. Advertising content may be placed at any location on a content page or application (e.g., mobile application), and may be presented both as part of a content stream as well as a standalone advertisement, placed strategically around or within the content stream. In some embodiments, advertisers 140 may include or may be configured as an ad exchange engine that serves as a platform for buying one or more advertisement opportunities made available by a publisher (e.g., publisher 130). The ad exchange engine may run an internal bidding among multiple advertisers associated with the engine, and submit a suitable bid to the publisher, after receiving and in response to a bid request from the publisher.

Activity and behavior log/database 150, which may be centralized or distributed, stores and provides data related to current and past user events (i.e., events that occurred previously in time with respect to the time of occurrence of the current user event) generated in accordance with or as a result of user interactions with online content and advertisements. The user event data (interchangeably referred to herein as visitor interaction data or visitor-publisher interaction data) may include information regarding entities (e.g., user(s), publisher(s), advertiser(s), ad creative(s), etc.) associated with each respective user event, and other event-related information. In some embodiments, after each user event is processed by engine 175, the user event data including, but not limited to, set(s) of behavior features, probabilistic values related to the feature value set(s), per-visitor impression/click data, traffic quality score(s), etc., may be sent to database 150 to be added to, and thus update, the past user event data.

Content sources 160 may include multiple content sources 160-a, 160-b, . . . , 160-c. A content source may correspond to a web page host corresponding to a publisher (e.g., a publisher 130) an entity, whether an individual, a business, or an organization such as USPTO.gov, a content provider such as CNN.com and Yahoo.com, or content feed source such as Twitter or blogs. Content sources 110 may be any source of online content such as online news, published papers, blogs, on-line tabloids, magazines, audio content, image content, and video content. It may be content from a content provider such as Yahoo! Finance, Yahoo! Sports, CNN, and ESPN. It may be multi-media content or text or any other form of content comprised of website content, social media content, such as Facebook, Twitter, Reddit, etc., or any other content rich provider. It may be licensed content from providers such as AP and Reuters. It may also be content crawled and indexed from various sources on the Internet. Content sources 110 provide a vast array of content to publishers 130 and/or other parts of system 100.

Traffic-fraud detection engine 170, as will be described in greater detail below, may be configured to generate or provide a representation of relationships between entities (e.g., visitors 110 and publishers 130) involved in online content interaction (where the relationship representations may not be dominated by certain one or more entities). Further, traffic-fraud detection engine 170 may be configured to group visitors 110 into clusters based on their relationship representations, and analyze the visitors 110 on a cluster level rather than individually, so as to determine whether the visitors 110 or their clusters are fraudulent. Traffic-fraud detection engine 170 may perform such analysis of visitor clusters based on cluster-level metrics, which, e.g., leverage statistics of traffic behavior features of visitors 110, which features may be provided by activity and behavior processing engine 175 and stored at log 150.

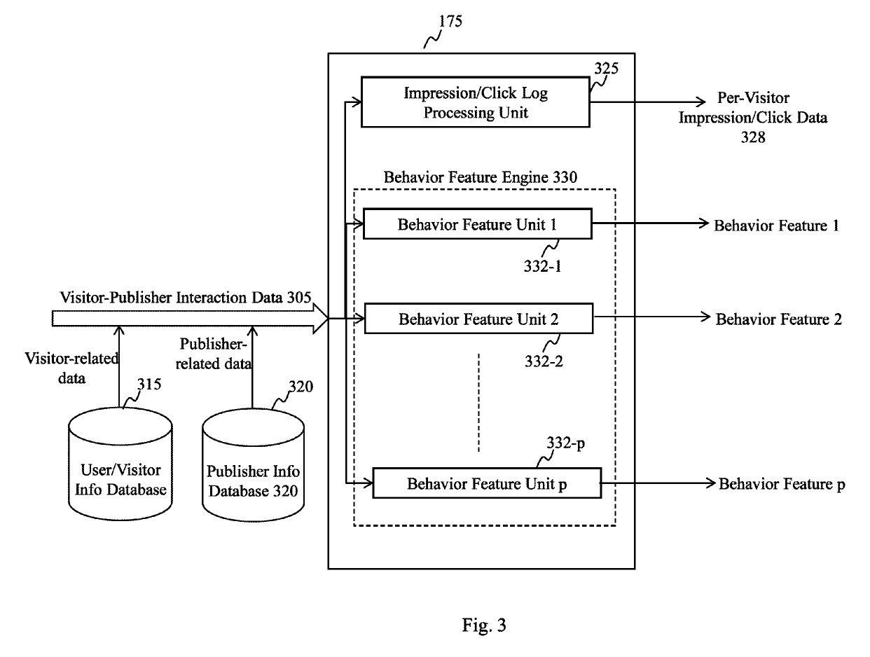

Activity and behavior processing engine 175 may be configured to operate as a backend system of publisher 130 and advertiser 140 to receive, process and store information about user events related to user interaction (e.g., ad impression, ad click, ad conversion, etc.) with the online content including advertisements provided to users 110 at their devices. For example, as illustrated in FIG. 3, activity and behavior processing engine 175 may receive interaction or event data 305 from the related publisher 130 and/or the advertiser 140 (that provided the content and advertisement), after the user 110 performs an interaction (e.g., ad click) with the presented online content.

The visitor-publisher interaction or event data 305 may include, but not limited to, type of the event, time of the event, contextual information regarding the content and advertisement (e.g., whether it relates to sports, news, travel, retail shopping, etc.) related to the user event, user's information (such as user's IP address, name, age, sex, location, other user identification information), e.g., from a database 315, identification information of the publisher(s) 130 related to this particular event), e.g., from a database 320, identification information of the advertiser(s) 140 related to this particular event, and identification information of other entities/participants (e.g., ad creative(s)) related to this particular event. The foregoing event-related information may be provided to engine 175 upon occurrence of each event for each user 110, each publisher 130 and each advertiser 140. In some other cases, such information is processed and recorded by engine 175 only for a specific set of users 110, publishers 130 and/or advertisers 140. In some embodiments, engine 175 may include a database (not shown) to store, in a specific category(-ies) and format(s), information related to users 110, publishers 130 and advertisers 140 and other entities of system 100. Further, engine 175 may be configured to update its database (periodically, or on demand), with the latest information about the entities related to system 200, e.g., as and when publishers 130, advertisers 140, etc. join or leave the system 200.

Still referring to FIG. 3, activity and behavior processing engine 175 may include an impression/click log processing unit 325 and a behavior feature engine 330. The impression/click log processing unit 325 may be configured to process the inputted interaction data 305 related to multiple visitor-publisher events or interactions, and determine per-visitor impression/click data 328, i.e., a number of times each unique user or visitor 110 views or clicks content provided by each unique publisher 130. For example, data 328 may include, for each visitor vᵢ, values c_{i,j}, i.e., a number of times visitor vᵢ viewed or clicked on content and/or ads by publisher pⱼ. Activity and behavior processing engine 175 may send per-visitor impression/click data 328 for storage at database 150.

Further, behavior feature engine 330 including behavior feature units 332-1, 332-2, . . . , 332-p may be configured to process the inputted interaction data 305 to determine various different behavior features indicating a visitor's behaviors with respect to its interactions with online content. In some embodiments, to generate the behavior features, behavior feature engine 330 may employ techniques and operations to generate feature sets or traffic divergence features described in U.S. patent application Ser. No. 14/401,601, the entire contents of which are incorporated herein by reference. Behavior feature unit 332-1 may generate behavior feature 1 indicating average publisher impression/click count for a specific visitor 110, which behavior feature 1 may be calculated as:

$$\frac{total number of impressions or clicks of a visitor 110}{number of distinct publishers accessed by that visitor 110} \qquad ( 1 )$$

Similarly, other behavior features 2, . . . , p generated by behavior feature units 2, . . . , p may indicate average impression/click count for a specific visitor 110 with respect to certain specific entities and are calculated based on a similar relation as in equation (1) above. For example, for a specific visitor 110, behavior features 2, . . . , p may include average advertiser impression/click count, average creative impression/click count, average user-agent impression/click count, average cookie impression/click count, average section impression/click count, and/or other online traffic-related behavior features. Upon generation, behavior features 1-p for each unique visitor or user 110 may be sent by activity and behavior processing engine 175 for storage at database 150.

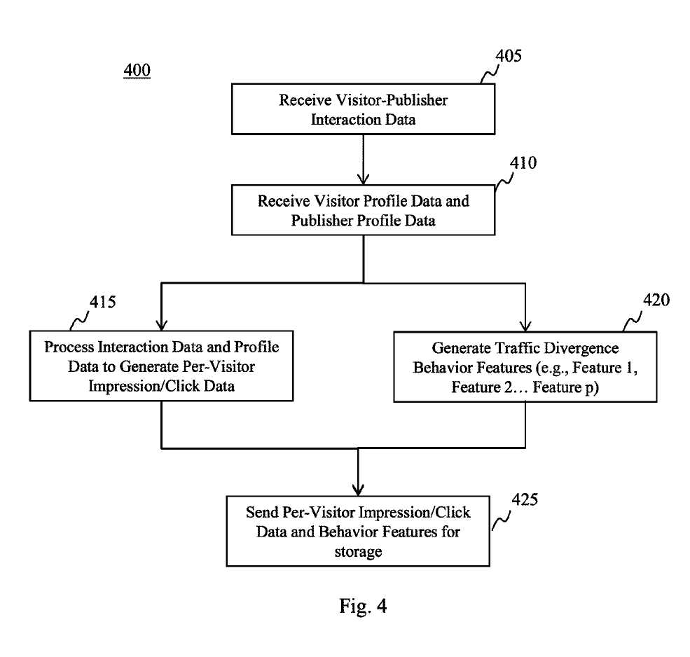

FIG. 4 is a flowchart of an exemplary process 400 operated at activity and behavior processing engine 175, according to an embodiment of the present disclosure. At 405, interaction or event data (e.g., data 305) may be received at activity and behavior processing engine 175 from the related publisher 130 and/or the advertiser 140 (that provided the content and advertisement), after the user 110 performs an interaction (e.g., ad click) with the online content. At 410, profile and identification data related to visitors and publishers (and other entities) involved in online interaction may be received at activity and behavior processing engine 175 from, e.g., databases 315, 320, or directly from the visitors and publishers. In some embodiments, such profile and identification data may be part of data 305 (received at operation 405). At 415, the received interaction/event data and the profile/identification data are processed, e.g., by impression/click log processing unit 325, to determine per-visitor impression/click data 328, i.e., a number of times each unique user or visitor 110 views or clicks content provided by each unique publisher 130. At 420, the received interaction/event data and the profile/identification data are processed, e.g., by behavior feature engine 330 including behavior feature units 332-1, 332-2, . . . , 332-p, to determine behavior features 1-p, e.g., based on equation (1). At 425, per-visitor impression/click data 328 and behavior features 1-p may be sent or transmitted by activity and behavior processing engine 175 to database 150 to store that data therein.

Referring back to FIG. 2(a), in addition to a user at 110, a different type of user such as 180, which may be a system operator or an administrator, may also be able to interact with different components of system 200, e.g., traffic-fraud detection engine 170, etc. for different administrative jobs such as managing the activity and behavior log 150, activity and behavior processing engine 175, etc. In some embodiments, user 180 may be classified to have a higher privilege to manage activity and behavior log 150 and/or activity and behavior processing engine 175 on more operational issues than user 110. For example, user 180 may be configured to be able to update the indexing scheme or format of data stored in the activity and behavior log 150, the format of data collected using engine 175, or testing traffic-fraud detection engine 170. In some embodiments, traffic-fraud detection engine 170 and the related activity and behavior log 150 may be part of a third party service provider so that the publishers 130, advertisers 140 and user 180 may be customers of traffic-fraud detection engine 170. In this case, user 180 may configure separate data or process so that the service to different customers may be based on different data or process operational parameters to provide individualized services.

FIG. 2(b) presents a similar system configuration as what is shown in FIG. 2(a) except that the advertisers 140 are now configured as a backend sub-system of the publishers 130. In some embodiments (not shown), there may be yet another different system configuration in which the administrator user 180 may solely manage traffic-fraud detection engine 170 and the log 150 via an internal or proprietary network connection. It is noted that different configurations as illustrated in FIGS. 2(a), 2(b) may also be mixed in any manner that is appropriate for a particular application scenario.

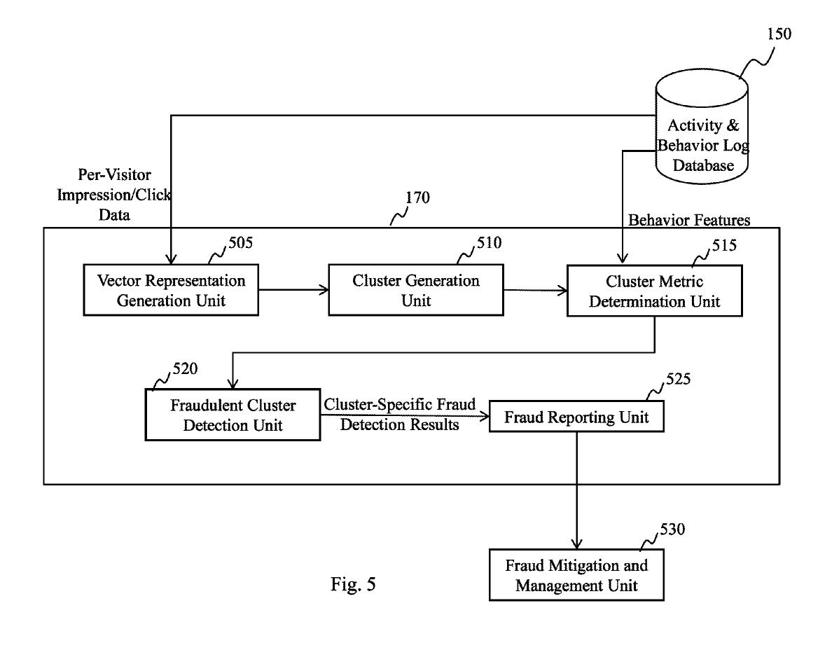

Referring to FIG. 5, which is a high level depiction of an exemplary traffic-fraud detection engine 170, according to an embodiment of the present disclosure. Traffic-fraud detection engine 170 may be configured to generate or provide a representation of relationships between entities (e.g., visitors 110 and publishers 130) involved in online content interaction. Further, traffic-fraud detection engine 170 may be configured to determine whether the visitors 110 or their clusters are fraudulent, based on cluster-level metrics. To achieve these and other functionalities, traffic-fraud detection engine 170 may include a vector representation generation unit 505, a cluster generation unit 510, a cluster metric determination unit 515, a fraudulent cluster detection unit 520, and a fraud reporting unit 525.

In some embodiments, a vector representation generation unit 505 is configured to generate or provide a vector or set representation of relationships for each visitor 110, where the relationship representation set includes values indicating extent of online interaction (e.g., impressions, views, clicks, etc.) that visitor had with one or more publishers 130. Typically, an interaction relationship between an i^{th} visitor, vᵢ and j^{th} publisher, pⱼ is represented by c_{i,j}, i.e., a number of times visitor vᵢ viewed or clicked on content and/or ads by publisher pⱼ, and the interaction relationship between visitor vᵢ and all of the publishers in the system is represented by a following vector:

vᵢ=(c_{i,1}c_{i,2}, . . . ,c_{i,m}), i=1,2, . . . ,n (2)

where n and m are the numbers of total visitors (e.g., visitors or users 110) and publishers (e.g., publishers 130), respectively.

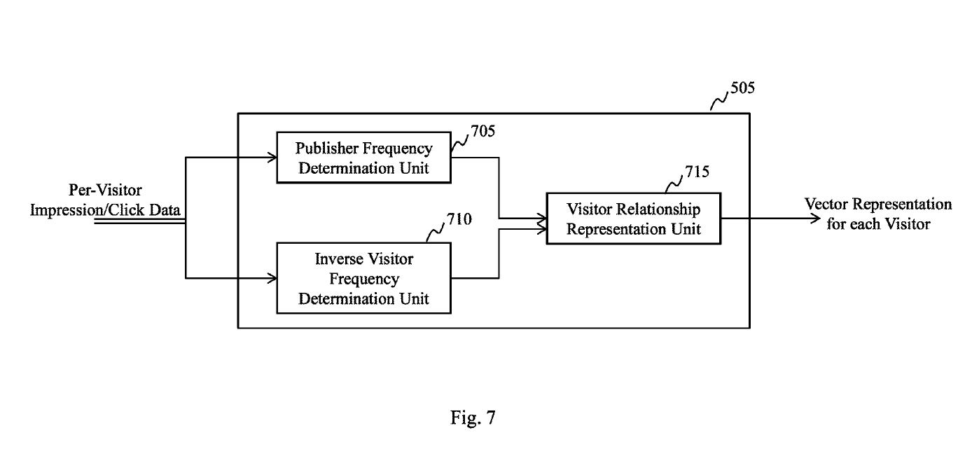

However, there may be some drawbacks using the raw view or click numbers on publishers as features to determine whether a particular visitor is a fraud. For example, a publisher (e.g. www.yahoo.com) may be so popular that most of visitors have large traffic, and thus, larger c_{i,j} value with respect to the popular publisher. As such, interaction relationship vectors of a plurality of visitors may be dominated by a specific publisher, since the c_{i,j} value on the publisher dimension is very large, and that plurality of visitors may be hard to differentiate from each other. Accordingly, to address this drawback of a dominating publisher, the present disclosure proposes a technique to consider “weights” for publishers into consideration. This technique provides representations of visitors based on publisher frequency and inverse visitor frequency. In that regard, FIG. 7 shows a high level depiction of an exemplary vector representation generation unit 505, according to an embodiment of the present disclosure. As shown, vector representation generation unit 505 includes a publisher frequency determination unit 705, an inverse visitor frequency determination unit 710, and a visitor relationship representation unit 715.

Vector representation generation unit 505 receives (e.g., via a communication platform of traffic-fraud detection engine 170) per-visitor impression/click data 328 from database 150 for each visitor 110 into consideration, and that data is provided to publisher frequency determination unit 705 and an inverse visitor frequency determination unit 710 for further processing. Publisher frequency determination unit 705 (or “a first frequency unit”) may be configured to determine, for each visitor vᵢ, a publisher frequency value pfᵢⱼ corresponding to publisher pⱼ, based on the following equation:

$${pf}_{ij} = \frac{{c}_{ij}}{{s}_{i}} \qquad ( 3 )$$

where sᵢ is the total traffic generated by visitor vᵢ:

sᵢ=Σⱼ₌₁^{m}cᵢⱼ (4)

Inverse visitor frequency determination unit 710 (or “a second frequency unit”) may be configured to determine, for each publisher pⱼ, an inverse visitor frequency value ivfⱼ based on the following equation:

ivfⱼ=log(n/tⱼ) (5)

where tⱼ is the number of distinct visitors who visit or access publisher pⱼ, and is calculated as:

tⱼ=Σᵢ₌₁ⁿδ(cᵢⱼ>0) (6)

where δ(x) is an indicator function which maps x to 1 if x is true, otherwise to 0. The inverse visitor frequency value ivfⱼ for publisher pⱼ may be considered as a “weight” for that publisher in the context of representing relationship between visitors and the publisher.

Publisher frequency determination unit 705 and inverse visitor frequency determination unit 710 provide the publisher frequency values and inverse visitor frequency values to visitor relationship representation unit 715. Visitor relationship representation unit 715 may be configured to determine, for each visitor vᵢ, a set of relationship values wᵢⱼ based on the set of publisher frequency values for that visitor vᵢ and the inverse visitor frequency values for publisher pⱼ. Each relationship values wᵢⱼ indicates a weighted interaction relationship value between that visitor vᵢ, and publisher pⱼ, and is calculated by visitor relationship representation unit 715 based on the following equation:

wᵢⱼ=pfᵢⱼ×ivfⱼ (7)

Visitor relationship representation unit 715 may also arrange relationship values wᵢⱼ for each visitor vᵢ in a vector form denoted as:

wᵢ=(wᵢ₁,wᵢ₂, . . . ,wᵢₘ) (8)

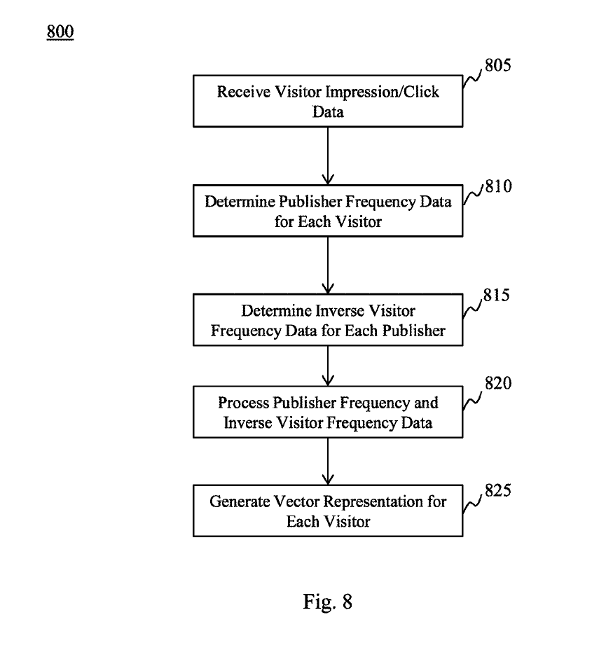

FIG. 8 is a flowchart of an exemplary process 800 operated at vector representation generation unit 505, according to an embodiment of the present disclosure. At 805, per-visitor impression/click data 328 is received, e.g., from database 150. At 810, for each visitor vᵢ, a publisher frequency value pfᵢⱼ corresponding to publisher pⱼ, is determined, e.g., using publisher frequency determination unit 705, based on equations (3), (4). At 815, for each publisher pⱼ, an inverse visitor frequency value ivfⱼ is determined, e.g., by inverse visitor frequency determination unit 710, based on equations (5), (6). At 820, publisher frequency and inverse visitor frequency values may be processed, e.g., by visitor relationship representation unit 715, to determine, for each visitor vᵢ, a set of relationship values wᵢⱼ based on the set of publisher frequency values for that visitor vᵢ and the inverse visitor frequency values for publisher pⱼ, based on equation (7). And, at 825, relationship values wᵢⱼ for each visitor vᵢ may be arranged in a vector form as shown in equation (8).

Referring back to FIG. 5, cluster generation unit 510 may be configured to cluster or group visitors or users 110 based on or using their relationship value vectors from vector representation generation unit 505. In some embodiments, cluster generation unit 510 may cluster visitors 110 based on well-known clustering algorithms such as, for example, algorithms based on hierarchical clustering, centroid-based clustering (e.g., K-means clustering), distribution-based clustering, density-based clustering, and/or other clustering techniques. For example, cluster generation unit 510 employs K-means clustering; the number of total visitor clusters K is preconfigured or preset to a fixed number, e.g., 972, with each cluster of an average size of 50 visitors.

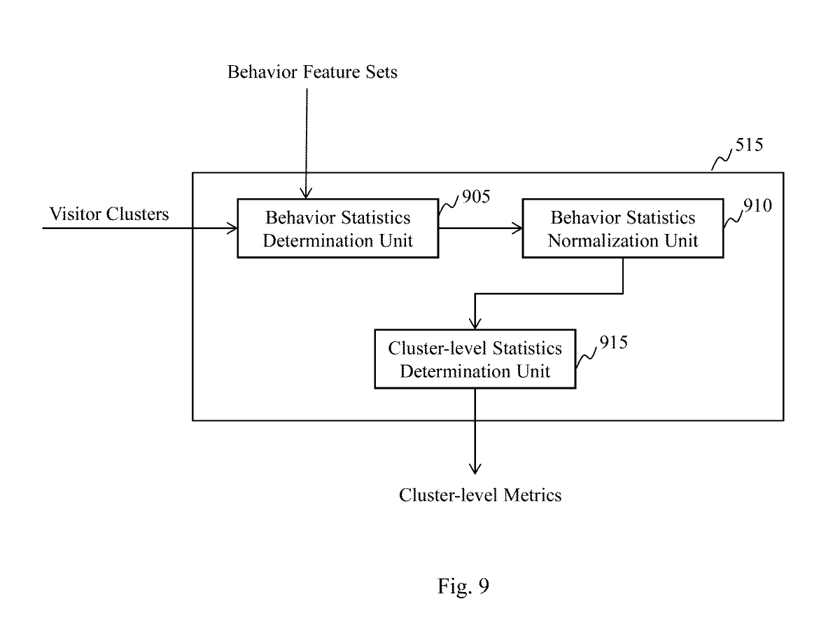

Cluster metric determination unit 515 may be configured to determine certain metrics for each cluster that represent behavior of the cluster, e.g., based on behavior features of each visitor in the cluster. In that regard, FIG. 9 shows a high level depiction of an exemplary cluster metric determination unit 515, according to an embodiment of the present disclosure. As shown, cluster metric determination unit 515 includes a behavior statistics determination unit 905, a behavior statistics normalization unit 910, and a cluster-level statistics determination unit 915.

Cluster metric determination unit 515 receives (e.g., via a communication platform of traffic-fraud detection engine 170) behavior features 1-p of each visitor 110 from database 150, and visitor clusters from cluster generation unit 510. In some embodiments, behavior statistics determination unit 905 is configured to determine, for each cluster k, statistics (e.g., mean and variance) of each of the behavior features 1-p of all the visitors in the cluster k. For example, let K be the total number of clusters, nₖ be the number of visitors in the k^{th} cluster, and x_{iq}(k) be the q^{th} behavior feature of the i^{th} visitor in cluster k. Then, behavior statistics determination unit 905 is configured to determine a mean value of the q^{th} behavior feature in cluster k, which, in some embodiments, represents a level of suspiciousness of the cluster being a fraudulent cluster, and is calculated based on:

$${μ}_{q}^{k} = \frac{1}{{n}_{k}} {\sum }_{i = 1}^{{n}_{k}} {x}_{iq}^{k} \qquad ( 9 )$$

Further, behavior statistics determination unit 905 is configured to determine a variance or standard deviation value of the q^{th} behavior feature in cluster k, which, in some embodiments, represents a level of similarity among visitors of the cluster, and is calculated based on:

$${σ}_{q}^{k} = \frac{1}{{μ}_{q}^{k}} \sqrt{\frac{1}{{n}_{k}} {\sum }_{i = 1}^{{n}_{k}} {( {x}_{iq}^{k} - {μ}_{q}^{k} )}^{2}} \qquad ( 10 )$$

Behavior statistics normalization unit 910 may be configured to normalize the behavior statistics determined by behavior statistics determination unit 905 discussed above. For example, behavior statistics normalization unit 910 may determine a mean value and a standard deviation of the mean values of the q^{th} feature in all of the clusters K respectively as:

m_{μ}_{_{q}}=mean{μ_{q}¹,μ_{q}², . . . ,μ_{q}^{K}},

and

s_{μ}_{_{q}}=std. dev. {μ_{q}¹,μ_{q}², . . . ,μ_{q}^{K}} (11)

Similarly, behavior statistics normalization unit 910 may determine a mean value and a standard deviation (or variance) of the standard deviation (or variance) values of the q^{th} feature in all of the clusters K respectively as:

m_{σ}_{_{q}}=mean{σ_{q}¹,σ_{q}², . . . ,σ_{q}^{K}},

and

s_{σ}_{_{q}}=std. dev. {σ_{q}¹,σ_{q}², . . . ,σ_{q}^{K}} (12)

Behavior statistics normalization unit 910 may calculate normalized mean and standard deviation of each q^{th} feature in each clusters k as:

$${{μ}^{⋁}}_{q}^{k} = \frac{{μ}_{q}^{k} - {m}_{{μ}_{q}}}{{s}_{{μ}_{q}}} , and {{σ}^{⋁}}_{q}^{k} = \frac{{σ}_{q}^{k} {m}_{{σ}_{q}}}{{s}_{{σ}_{q}}} \qquad ( 13 )$$

Further, cluster-level statistics determination unit 915 may sum up, for each cluster k, the normalized mean and standard deviation values from equation (13) over all of the behavior features 1-p in the cluster k to determine two cluster-level metrics (Mₖ and Sₖ) for cluster k. This summation is represented by the following equation:

$${M}_{k} = {\sum }_{q = 1}^{p} {{μ}^{⋁}}_{q}^{k} , {S}_{k} = {\sum }_{q = 1}^{p} {{σ}^{⋁}}_{q}^{k} \qquad ( 14 )$$

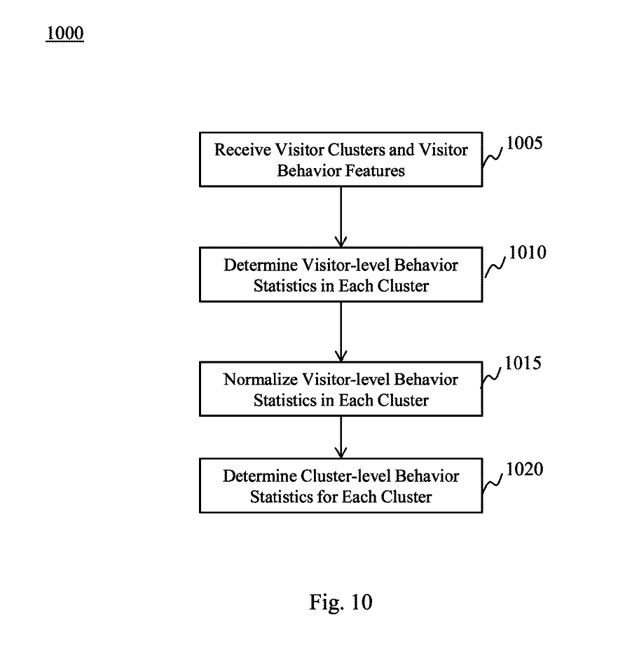

FIG. 10 is a flowchart of an exemplary process 1000 operated at cluster metric determination unit 515, according to an embodiment of the present disclosure. At 1005, visitor clusters and visitor behavior features for all visitors in the clusters may be received. At 1010, behavior statistics (mean and standard deviation/variance) of all behavior features in each cluster may be determined, e.g., based on equations (9), (10). At 1015, the behavior statistics may be normalized, e.g., based on equations (11)-(13). At 1020, two cluster-level metrics (Mₖ and Sₖ) for cluster k may be determined, e.g., based on equation (14).

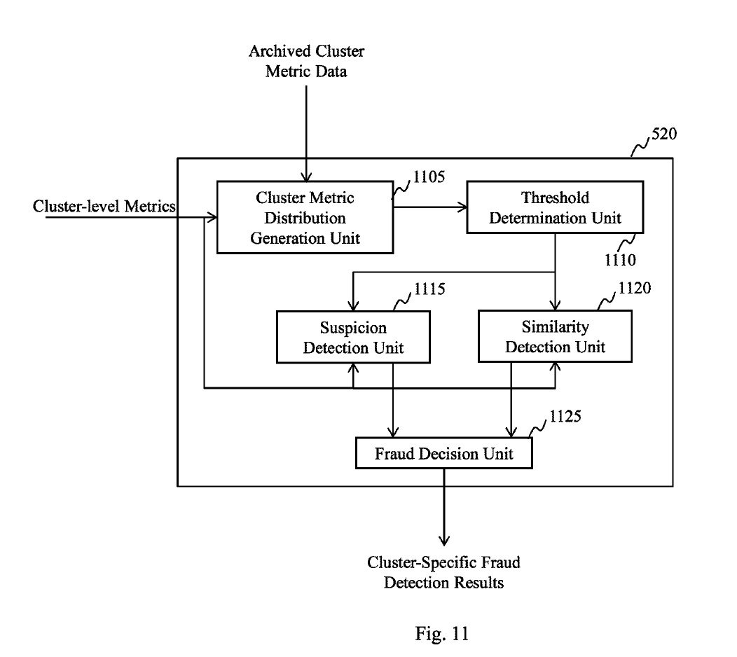

Referring back to FIG. 5, the cluster metrics are provided to fraudulent cluster detection unit 520 that is configured to determine whether a particular cluster of visitors is fraudulent (i.e., whether the visitors are collaborating with publishers to fraudulently inflate traffic toward the publishers) based on a comparison of the cluster metrics with certain threshold values. In that regard, FIG. 11 shows a high level depiction of an exemplary fraudulent cluster detection unit 520, according to an embodiment of the present disclosure. As shown, fraudulent cluster detection unit 520 includes a cluster metric distribution generation unit 1105, a threshold determination unit 1110, a suspicion detection unit 1115, a similarity detection unit 1120, and a fraud decision unit 1125.

In some embodiments, cluster metric distribution generation unit 1105 receives (e.g., via a communication platform of traffic-fraud detection engine 170) cluster-level metrics (Mₖ and Sₖ) for each of the K clusters, and archived cluster metric data, and calculates probability distributions of each cluster metric. Threshold determination unit 1110 is configured to determine a threshold value for each cluster metric based on the corresponding probability distribution provided by cluster metric distribution generation unit 1105. For example, threshold determination unit 1110 may determine threshold θ_{M}=0.75 for metric Mₖ, and θ_{S}=0.25 for metric Sₖ. In some embodiments, the two thresholds may not be calculated, and may be provided as preconfigured values, e.g., by an administrator.

In some embodiments, cluster metric Mₖ indicates a level of suspiciousness of the cluster being a fraudulent cluster. Suspicion detection unit 1115 is configured to compare cluster metric Mₖ for each cluster k with the threshold θ_{M}, and any cluster metric Mₖ greater than threshold θ_{M} may indicate that the cluster k is suspicious. The larger the cluster metric Mₖ is, the more suspicious the cluster k is.

In some embodiments, cluster metric Sₖ indicates a level of similarity among visitors of the cluster. Similarity detection unit 1120 is configured to compare cluster metric Sₖ for each cluster k with the threshold θ_{S}, and any cluster metric Sₖ smaller than threshold θ_{S} may indicate that the visitors in cluster k are highly similar. The smaller the cluster metric Sₖ is, the more similar the visitor in the cluster k are.

In some embodiments, fraud decision unit 1125 is configured to decide whether a cluster k is fraudulent based on the threshold comparison results from suspicion detection unit 1115 and similarity detection unit 1120. For example, fraud decision unit 1125 may generate a result determining that a cluster k is fraudulent if:

(a) Mₖ>θ_{M}; or (b) Sₖ<θ_{S}, or (c) Mₖ>θ_{M} and Sₖ<θ_{S} (15)

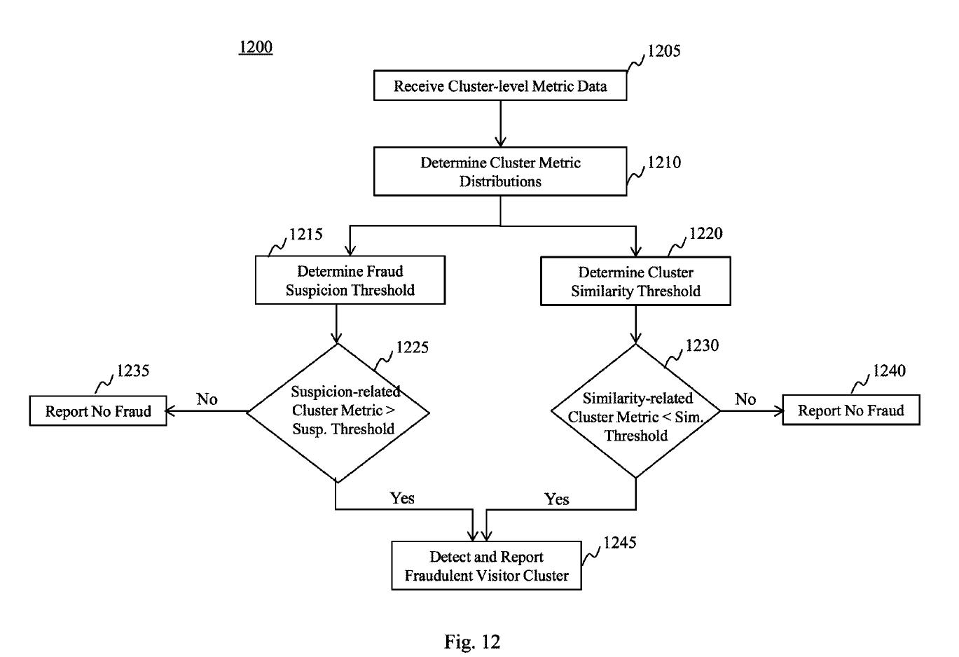

FIG. 12 is a flowchart of an exemplary process 1200 operated at fraudulent cluster detection unit 520, according to an embodiment of the present disclosure. At 1205, cluster metric data from cluster metric determination unit 515 and archived cluster metric data from database 150 may be received at cluster metric distribution generation unit 1105. At 1210, probability distributions of each cluster metric may be determined, and at 1215 and 1220, a suspicion threshold, i.e., a threshold θ_{M} for cluster metric Mₖ, and a similarity threshold, i.e., a threshold θ_{S} for cluster metric Sₖ may be determined, respectively, based on the probability distributions.

At 1225 and 1230, comparison determinations are made as to whether cluster metric Mₖ is greater than threshold θ_{M}, and a comparison determination is made as to whether cluster metric Sₖ is smaller than threshold θ_{S}. If the result of either of those two comparisons is “no,” at 1235, 1240, a message is sent, e.g., by fraud reporting unit 525, that the visitor cluster k is not fraudulent in terms of collaborative fake online traffic activities. If the result of either (or both) of those two comparisons is “yes,” at 1245, the visitor cluster k is determined to be fraudulent in terms of collaborative fake online traffic activities, and that decision message is reported, e.g., by fraud reporting unit 525, to fraud mitigation and management unit 530, which unit 530 may flag or take action against the visitors 110 and related publishers 130 in the fraudulent clusters, e.g., to remove or minimize the fraudulent entities from system 200.

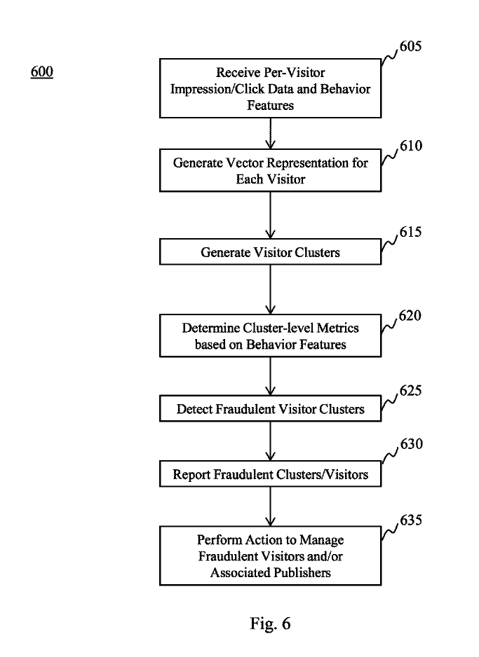

FIG. 6 is a flowchart of an exemplary process 600 operated at fraud detection engine 170, according to an embodiment of the present disclosure. At 605, per-visitor impression/click data and behavior features are received from database 150. At 610, a vector relationship representation for each visitor is generated, e.g., using vector representation generation unit 505. Based on the vector relationship representations, at 615, visitors 110 are grouped into clusters, e.g., using cluster generation unit 510. At 620, cluster-level metrics for each cluster are determined based on behavior features of the cluster's visitors, e.g., using cluster metric determination unit 515. At 625, a determination is made for each cluster whether that clusters is fraudulent, e.g., using fraudulent cluster detection unit 520. At 630, clusters or visitors (and related publishers) which are determined to be fraudulent are reported, e.g., using fraud reporting unit 525, to other publishers, advertisers, visitors, and/or other entities of system 200 involved in online activity. At 635, one or more actions may be taken, e.g., by fraud mitigation and management unit 530 to flag or take action against the fraudulent visitors 110 and related publishers 130.

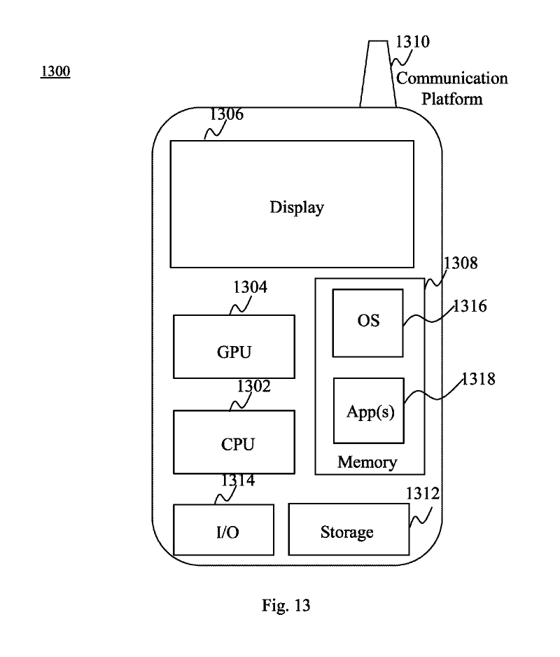

FIG. 13 depicts the architecture of a mobile device which can be used to realize a specialized system implementing the present teaching. In this example, the user device on which content and advertisement are presented and interacted-with is a mobile device 1300, including, but is not limited to, a smartphone, a tablet, a music player, a handled gaming console, a global positioning system (GPS) receiver, and a wearable computing device (e.g., eyeglasses, wrist watch, etc.), or in any other form factor. The mobile device 1300 in this example includes one or more central processing units (CPUs) 1302, one or more graphic processing units (GPUs) 1304, a display 1306, a memory 1308, a communication platform 1310, such as a wireless communication module, storage 1312, and one or more input/output (I/O) devices 1314. Any other suitable component, including but not limited to a system bus or a controller (not shown), may also be included in the mobile device 1300. As shown in FIG. 13, a mobile operating system 1316, e.g., iOS, Android, Windows Phone, etc., and one or more applications 1318 may be loaded into the memory 1308 from the storage 1312 in order to be executed by the CPU 1302. The applications 1318 may include a browser or any other suitable mobile apps for receiving and rendering content streams and advertisements on the mobile device 1300. User interactions with the content streams and advertisements may be achieved via the I/O devices 1314, and provided to the components of system 200 and/or other similar systems, e.g., via the network 120.

To implement various modules, units, and their functionalities described in the present disclosure, computer hardware platforms may be used as the hardware platform(s) for one or more of the elements described above. The hardware elements, operating systems and programming languages of such computers are conventional in nature, and it is presumed that those skilled in the art are adequately familiar therewith to adapt those technologies to infer user identity across different applications and devices, and create and update a user profile based on such inference. A computer with user interface elements may be used to implement a personal computer (PC) or other type of work station or terminal device, although a computer may also act as a server if appropriately programmed. It is believed that those skilled in the art are familiar with the structure, programming and general operation of such computer equipment and as a result the drawings should be self-explanatory.

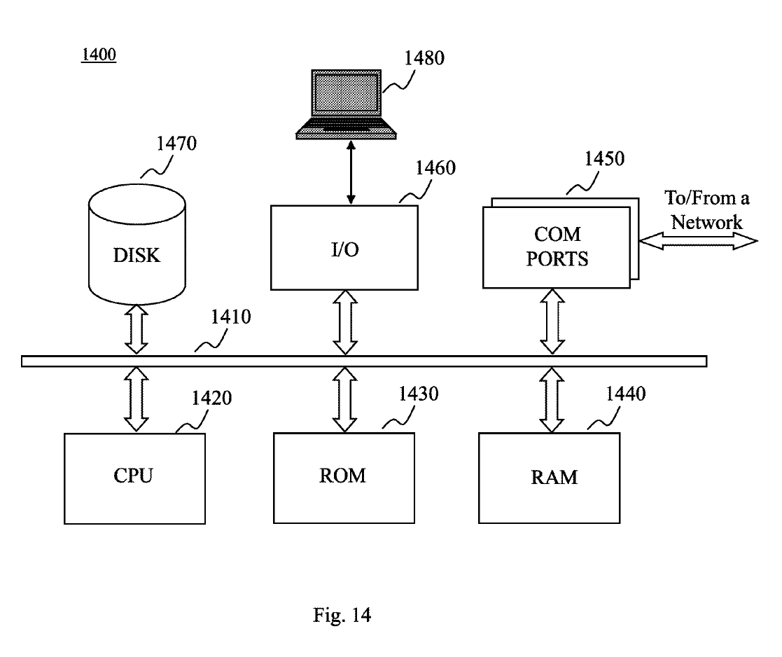

FIG. 14 depicts the architecture of a computing device which can be used to realize a specialized system implementing the present teaching. Such a specialized system incorporating the present teaching has a functional block diagram illustration of a hardware platform which includes user interface elements. The computer may be a general purpose computer or a special purpose computer. Both can be used to implement a specialized system for the present teaching. This computer 1400 may be used to implement any component of user profile creation and updating techniques, as described herein. For example, traffic-fraud detection engine 170, activity and behavior processing engine 175, etc., may be implemented on a computer such as computer 1400, via its hardware, software program, firmware, or a combination thereof. Although only one such computer is shown, for convenience, the computer functions relating to providing a representation of relationships between entities involved in online content interaction and detecting coalition fraud in online or internet-based activities and transactions as described herein may be implemented in a distributed fashion on a number of similar platforms, to distribute the processing load.

The computer 1400, for example, includes COM ports (or one or more communication platforms) 1450 connected to and from a network connected thereto to facilitate data communications. Computer 1400 also includes a central processing unit (CPU) 1420, in the form of one or more processors, for executing program instructions. The exemplary computer platform includes an internal communication bus 1410, program storage and data storage of different forms, e.g., disk 1470, read only memory (ROM) 1430, or random access memory (RAM) 1440, for various data files to be processed and/or communicated by the computer, as well as possibly program instructions to be executed by the CPU. Computer 1400 also includes an I/O component 1460, supporting input/output flows between the computer and other components therein such as user interface elements 1480. Computer 1400 may also receive programming and data via network communications.

Hence, aspects of the methods of enhancing ad serving and/or other processes, as outlined above, may be embodied in programming Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives and the like, which may provide storage at any time for the software programming.

All or portions of the software may at times be communicated through a network such as the Internet or various other telecommunication networks. Such communications, for example, may enable loading of the software from one computer or processor into another, for example, from a management server or host computer of a search engine operator or other user profile and app management server into the hardware platform(s) of a computing environment or other system implementing a computing environment or similar functionalities in connection with user profile creation and updating techniques. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine-readable medium may take many forms, including but not limited to, a tangible storage medium, a carrier wave medium or physical transmission medium. Non-volatile storage media include, for example, optical or magnetic disks, such as any of the storage devices in any computer(s) or the like, which may be used to implement the system or any of its components as shown in the drawings. Volatile storage media include dynamic memory, such as a main memory of such a computer platform. Tangible transmission media include coaxial cables; copper wire and fiber optics, including the wires that form a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a physical processor for execution.

Those skilled in the art will recognize that the present teachings are amenable to a variety of modifications and/or enhancements. For example, although the implementation of various components described above may be embodied in a hardware device, it may also be implemented as a software only solution—e.g., an installation on an existing server. In addition, the enhanced ad serving based on user curated native ads as disclosed herein may be implemented as a firmware, firmware/software combination, firmware/hardware combination, or a hardware/firmware/software combination.

While the foregoing has described what are considered to constitute the present teachings and/or other examples, it is understood that various modifications may be made thereto and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

We claim:

1. A method to detect online coalition fraud, implemented on a machine having a processor, a storage unit, and a communication platform capable of making a connection to a network, the method comprising:
grouping visitors that interact with online content into clusters;
obtaining traffic features for each visitor, wherein the traffic features are based at least on data representing the corresponding visitor's interaction with the online content;
determining, for each cluster, cluster metrics based on the traffic features of the visitors in that cluster; and
determining whether a first of the clusters is fraudulent based on the cluster metrics of the first cluster.

2. The method of claim 1, wherein each individual traffic feature is related to a corresponding one of a set of entity types, and said obtaining the traffic features of a visitor includes determining each individual traffic feature based on the data representing the visitor's interaction with the online content and data representing a relationship between the visitor and the corresponding one of the set of entity types.

3. The method of claim 2, wherein the set of entity types comprises a cookie, a user agent, a publisher of the online content, an advertiser that advertises in association with the online content, and a creative entity.

4. The method of claim 2, wherein the data representing the visitor's interaction with the online content includes a number of impressions or clicks of the online content for the visitor, and for each of the set of the entity types, the data representing the relationship between the visitor and that entity type includes a number of distinct entities of that entity type related to the visitor.

5. The method of claim 1, wherein said determining cluster metrics is based on one or more statistical values of the traffic features of the visitors in that cluster.

6. The method of claim 5, wherein a first of the statistical values of the traffic features related to a cluster indicates a level of suspiciousness of the cluster, and a second of the statistical values of the traffic features related to the cluster indicates a level of similarity among the visitors of the cluster.

7. The method of claim 6, wherein said determining whether the first of the clusters is fraudulent includes determining whether the first statistical value of the traffic features related to the first cluster is greater than a first threshold value, or determining whether the second statistical value of the traffic features related to the first cluster is lower than a second threshold value, or both.

8. A system to detect online coalition fraud, the system comprising:
a cluster generation unit configured to group visitors that interact with online content into clusters;
a cluster metric determination unit configured to determine, for each cluster, cluster metrics based on traffic features of each corresponding one of the visitors in that cluster, wherein the traffic features are based at least on data representing the corresponding visitor's interaction with the online content; and
a fraudulent cluster detection unit configured to determine whether a first of the clusters is fraudulent based on the cluster metrics of the first cluster.

9. The system of claim 8, wherein each individual traffic feature is related to a corresponding one of a set of entity types, the system further comprising a behavior processing engine configured to determine each individual traffic feature of a visitor based on the data representing the visitor's interaction with the online content and data representing a relationship between the visitor and the corresponding one of the set of entity types.

10. The system of claim 9, wherein the set of entity types comprises a cookie, a user agent, a publisher of the online content, an advertiser that advertises in association with the online content, and a creative entity.

11. The system of claim 9, wherein the data representing the visitor's interaction with the online content includes a number of impressions or clicks of the online content for the visitor, and for each of the set of the entity types, the data representing the relationship between the visitor and that entity type includes a number of distinct entities of that entity type related to the visitor.

12. The system of claim 8, wherein the cluster metric determination unit is configured to determine the cluster metrics based on one or more statistical values of the traffic features of the visitors in that cluster.

13. The system of claim 12, wherein a first of the statistical values of the traffic features related to a cluster indicates a level of suspiciousness of the cluster, and a second of the statistical values of the traffic features related to the cluster indicates a level of similarity among the visitors of the cluster.

14. The system of claim 13, wherein the fraudulent cluster detection unit is configured to determine whether the first statistical value of the traffic features related to the first cluster is greater than a first threshold value, or determine whether the second statistical value of the traffic features related to the first cluster is lower than a second threshold value, or both.

15. A machine readable, tangible, and non-transitory medium having information recorded thereon to detect online coalition fraud, where the information, when read by the machine, causes the machine to perform at least the following:
grouping visitors that interact with online content into clusters;
obtaining traffic features for each visitor, wherein the traffic features are based at least on data representing the corresponding visitor's interaction with the online content;
determining, for each cluster, cluster metrics based on the traffic features of the visitors in that cluster; and
determining whether a first of the clusters is fraudulent based on the cluster metrics of the first cluster.

16. The medium of claim 15, wherein each individual traffic feature is related to a corresponding one of a set of entity types, and said obtaining the traffic features of a visitor includes determining each individual traffic feature based on the data representing the visitor's interaction with the online content and data representing a relationship between the visitor and the corresponding one of the set of entity types.

17. The medium of claim 16, wherein the data representing the visitor's interaction with the online content includes a number of impressions or clicks of the online content for the visitor, and for each of the set of the entity types, the data representing the relationship between the visitor and that entity type includes a number of distinct entities of that entity type related to the visitor.

18. The medium of claim 15, wherein said determining cluster metrics is based on one or more statistical values of the traffic features of the visitors in that cluster.

19. The medium of claim 18, wherein a first of the statistical values of the traffic features related to a cluster indicates a level of suspiciousness of the cluster, and a second of the statistical values of the traffic features related to the cluster indicates a level of similarity among the visitors of the cluster.

20. The medium of claim 19, wherein said determining whether the first of the clusters is fraudulent includes determining whether the first statistical value of the traffic features related to the first cluster is greater than a first threshold value, or determining whether the second statistical value of the traffic features related to the first cluster is lower than a second threshold value, or both.
